(19) United States
(12) Patent Application Publication
(10) Pub. No.: US 2018/0146236 A1
(43) Pub. Date: May 24, 2018

(54) METHOD AND SYSTEM FOR SYNCHRONIZING PLAYBACK OF MULTIMEDIA FILES

(71) Applicant: ANI TECHNOLOGIES PRIVATE LIMITED, Bengaluru (IN)

(72) Inventors: Sriram V. Iyer, Bengaluru (IN); Vasuki K. Setlur, Bengaluru (IN); Arun Samudrala, Bengaluru (IN)

(21) Appl. No.: 15/816,585

(22) Filed: Nov. 17, 2017

(30) Foreign Application Priority Data
Nov. 19, 2016 (IN) 201641039545

(51) Int. Cl. H04N 21/43; H04N 21/6587; H04N 21/414; H04N 21/442; H04N 21/4363; H04N 21/6583; H04N 21/439

(52) U.S. Cl. CPC H04N 21/4307; H04N 21/6587; H04N 21/41422; H04N 21/439; H04N 21/43637; H04N 21/6583; H04N 21/44245

(57) ABSTRACT

A method for synchronizing a multimedia file shared between two or more devices is provided. The multimedia file is received by a first device. The multimedia file includes at least an audio component and a video component. The multimedia file is transmitted to a second device by way of a first communication network. The first device receives a plurality of control commands from the second device. Further, the first device synchronizes a playback of the audio component with the video component, based on the plurality of control commands. The first device renders the audio component by way of a first multimedia player and the second device renders the video component by way of a second multimedia player.

### CROSS-RELATED APPLICATIONS

This application claims priority of Indian Application Serial No. 201641039545, filed Nov. 19, 2016, the contents of which are incorporated herein by reference.

### FIELD OF THE INVENTION

The present invention relates generally to playback of multimedia files, and more particularly, to a system and method for synchronizing playback of audio and video components across multiple devices in an automotive environment.

### BACKGROUND

For travelling to and from work or engaging in a personal activity, commuters generally avail public and private transportation facilities. Hence, several vehicle service providers have adopted various schemes in order to entice passengers to use their services. These schemes generally focus on vehicle safety, efficiency, and passenger comfort. Some vehicle service providers have further installed an entertainment system in the vehicles, i.e., an in-vehicle entertainment system to provide a pleasant and joyful ride experience to the passengers. Such in-vehicle entertainment system includes a vehicle head unit, inbuilt speakers, and display screens for playing various multimedia files. The vehicle head unit controls the playback of the multimedia files through the speakers and the display screen of the in-vehicle entertainment system.

Some in-vehicle entertainment systems in the vehicle play the multimedia files that are received through broadcast signals. However, the broadcast signals may get affected due to poor reception, which may affect playback of the multimedia files through the speaker and the display screen. Further, the in-vehicle entertainment system installed in the vehicle does not have a provision to store the multimedia files locally. Therefore, the passengers travelling in the vehicle need to carry various media storage devices, such as compact discs (CDs), Universal serial bus (USB) drives, flash drives, and the like, to store and input the multimedia files into the in-vehicle entertainment system. This becomes very inconvenient for the passengers.

Most of the in-vehicle entertainment systems provide the passenger with full control of the entertainment system so that the driver can focus on driving the vehicle and the passengers can play the multimedia file of their choice. Thus, when the passenger selects one of the inputs, such as play, pause, stop, resume, and the like, by way of a remote control or a touchscreen, the vehicle head unit executes a corresponding command on the multimedia file. In one example, the passenger selects the input as “play” to play the multimedia file. Thus, the vehicle head unit renders an audio component of the multimedia file through the speaker and a video component of the multimedia file through the display screen.

As two different devices, i.e., the speaker and the display screen are used to render the audio and video components, respectively, thus synchronization of the audio and video components is performed using wireless fidelity (Wi-Fi) and Bluetooth. The vehicle head unit transmits the video component to the display screen through Wi-Fi and the audio component to the speaker through Bluetooth. Bluetooth and Wi-Fi usually work in the same frequency band, such as 2.4 to 2.4835 GHz. When the video component is served over Wi-Fi and the audio component is played locally using Bluetooth, there may be a delay between the audio/video streams due to streaming of the video component over Wi-Fi. This not only causes lip-sync errors but also ruins the travel experience of the passengers.

Hence, it would be advantageous to have an in-vehicle entertainment system that does not require the passenger to carry any additional hardware and synchronizes the playback of the video component and the audio component in a poorly received broadcast signal and to remove lip sync error.

### SUMMARY

In an embodiment of the present invention, a system for synchronizing a multimedia file shared between two or more devices is provided. The system includes a first device that includes a memory and a processor. The memory is configured to store the multimedia file. The multimedia file includes at least an audio component and a video component. The processor that communicates with the memory is configured to transmit the multimedia file to a second device by way of a first communication network. The processor is further configured to receive a plurality of control commands from the second device. The processor is further configured to synchronize a playback of the audio component with the video component based on the plurality of control commands. The first device renders the audio component by way of a first multimedia player and the second device renders the video component by way of a second multimedia player.

In another embodiment of the present invention, a method for synchronizing a multimedia file shared between two or more devices is provided. The multimedia file is received by a first device. The multimedia file includes at least an audio component and a video component. Further, the multimedia file is transmitted by the first device to a second device by way of a first communication network. A plurality of control commands is received by the first device from the second device. Further, a playback of the audio component and the video component is synchronized, based on the plurality of control commands. The first device renders the audio component by way of a first multimedia player and the second device renders the video component by way of a second multimedia player.

Various embodiments of the present invention provide a method and system for synchronizing a multimedia file shared between two or more devices in an automotive environment. A first device installed in a vehicle receives various multimedia files that include a first multimedia file, from a server. The first multimedia file includes an audio component and a video component. The first device is connected to the server by means of a first communication network. Further, the first device is connected to a second device by means of a second communication network. The first device transmits a list of available multimedia files to the second device to be presented to a passenger travelling in the vehicle. The passenger selects a multimedia file, i.e., the first multimedia file, from the list of multimedia files to be played. The second device transmits information pertaining to the selection of the first multimedia file to the first device. Based on the information, the first device transmits the first multimedia file to the second device through the second communication network. The passenger further provides an input to control the playback of the first multimedia file. In one example, the user provides first through fifth inputs. Based on the first through fifth inputs, the second control device generates control commands such as a play command, a pause command, a resume command, a seek command, and a stop command, respectively. The second device further transmits the control command to the first device through the second communication network. The first device synchronizes the playback of the audio component with the video component of the first multimedia file based on the control command.

The first device further takes into account a lag time caused due to message transfer through the second communication network for the synchronization of the playback of the audio component with the video component. The first device renders the audio component by means of a first multimedia player and the second device renders the video component by means of a second multimedia player. Hence, the first and second devices synchronize the first and second multimedia players to render the audio component and the video component, respectively. Therefore, the first device prevents the occurrence of a lip-sync error during the playback of multimedia files.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

FIG. 1 is a block diagram that illustrates a system environment for synchronizing a playback of multimedia files across multiple devices according to an embodiment of the present invention;

FIG. 2 illustrates a first device and a second device of the system environment of FIG. 1 according to an embodiment of the present invention;

FIG. 3A illustrates a process flow diagram for synchronizing the playback of multimedia files across the first and second devices of FIG. 2 based on a play command according to an embodiment of the present invention;

FIG. 3B illustrates a process flow diagram for synchronizing the playback of multimedia files across the first and second devices of FIG. 2 based on a pause command according to an embodiment of the present invention;

FIG. 3C illustrates a process flow diagram for synchronizing the playback of multimedia files across the first and second devices of FIG. 2 based on a resume command according to an embodiment of the present invention;

FIG. 3D illustrates a process flow diagram for synchronizing the playback of multimedia files across the first and second devices of FIG. 2 based on a seek command according to an embodiment of the present invention;

FIG. 3E illustrates a process flow diagram for synchronizing the playback of multimedia files across the first and second devices of FIG. 2 based on a stop command according to an embodiment of the present invention;

FIGS. 4A-4F, collectively, illustrate a flow chart of a method for synchronizing the playback of multimedia files across multiple devices in the system environment of FIG. 1 according to an embodiment of the present invention; and

FIG. 5 illustrates a block diagram of a computer system for synchronizing the playback of multimedia files across multiple devices in the system environment of FIG. 1 according to an embodiment of the present invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components, which constitutes a system for synchronizing playback of multimedia files across multiple devices. Accordingly, the components and the method steps have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

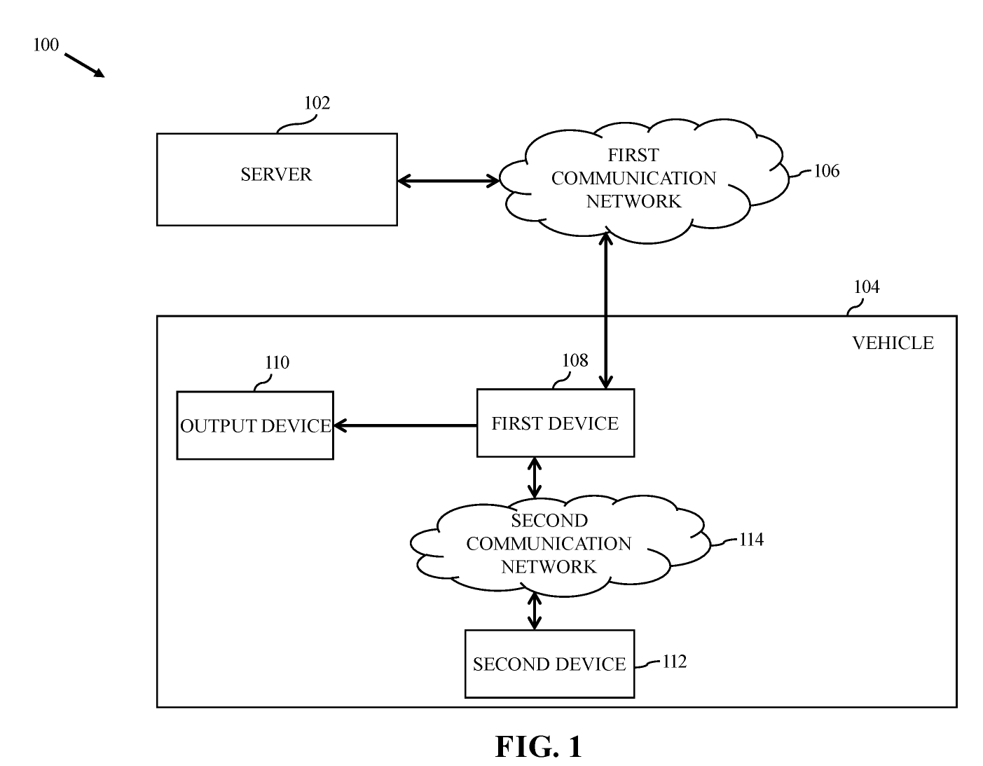

Referring now to FIG. 1, a system environment 100 for synchronizing a playback of multimedia files across multiple devices in accordance with an embodiment of the present invention is shown. The system environment 100 includes a server 102. In one example, the system environment 100 is implemented in an automotive environment that includes a vehicle 104. The server 102 transmits the multimedia files by way of a first communication network 106. The vehicle 104 includes a first device 108, an output device 110, and a second device 112. The first device 108 communicates with the second device 112 by way of a second communication network 114.

The server 102 is a content management server that manages entertainment content, such as the multimedia files of various movies, television shows, songs, audiobooks, and the like. Thus, a first multimedia file may correspond to a movie and a second multimedia file may correspond to a television show. The server 102 includes a processor (not shown) and a memory (not shown). The memory stores the multimedia files. Further, each multimedia file includes an audio component and a video component. The audio and video components include fragments of audio and video data, respectively. Each fragment of audio and video data is associated with a time stamp that indicates a time sequence in which the corresponding fragment of audio and video data is to be played. The fragments of audio data and video data that have the same time stamps are to be played at the same time instant for synchronization of the audio component with the video component. Thus, the audio and video components of one multimedia file, i.e., the first multimedia file, are synchronized by way of the time stamps. Examples of the server 102 include, but are not limited to, a personal computer, a laptop, or a network of computer systems. The server 102 transmits various multimedia files, such as the first multimedia file, to the first device 108 by way of the first communication network 106. Examples of the first communication network 106 include, but are not limited to, wireless fidelity (Wi-Fi) network, a light fidelity (Li-Fi) network, a satellite network, an internet, a mobile network such as cellular data, high speed packet access (HSPA), or any combination thereof.

The vehicle 104 corresponds to a means of transport that is deployed by a vehicle service provider, such as a taxicab provider, to provide ride services to passengers. In an embodiment, the vehicle 104 is an automobile, a bus, and the like. In another embodiment, the vehicle 104 is a train, an airplane, and the like. Passengers may travel in the vehicle 104 to commute from a source location to a destination location. Various methods of providing vehicle services to passengers used by the vehicle service provider will be apparent to a person having skill in the relevant art. The vehicle 104 includes the first device 108 for receiving the multimedia files from the server 102. In one embodiment, the first device 108 is a vehicle head unit. In another embodiment, the first device 108 is an external communication device that is placed in the vehicle 104. The vehicle 104 further includes the output device 110 that is connected to the first device 108. In an example, the first multimedia file includes a first audio component and a first video component. Thus, the output device 110 emits an audio signal of the first audio component. Examples of the output device 110 include speakers, headphones, and the like. The vehicle 104 further includes the second device 112 that communicates with the first device 108 by way of the second communication network 114. Examples of the second device 112 include a smartphone, a personal digital assistant (PDA), a tablet, or any other portable communication device. The second communication network 114 establishes a communication channel between the first and second devices 108 and 112. Examples of the second communication network 114 include a Wi-Fi network, a Bluetooth low-energy (BLE) network, a Li-Fi, a fiber optic network, a coaxial cable network, an infrared network, a radio frequency (RF) network, or any combination thereof.

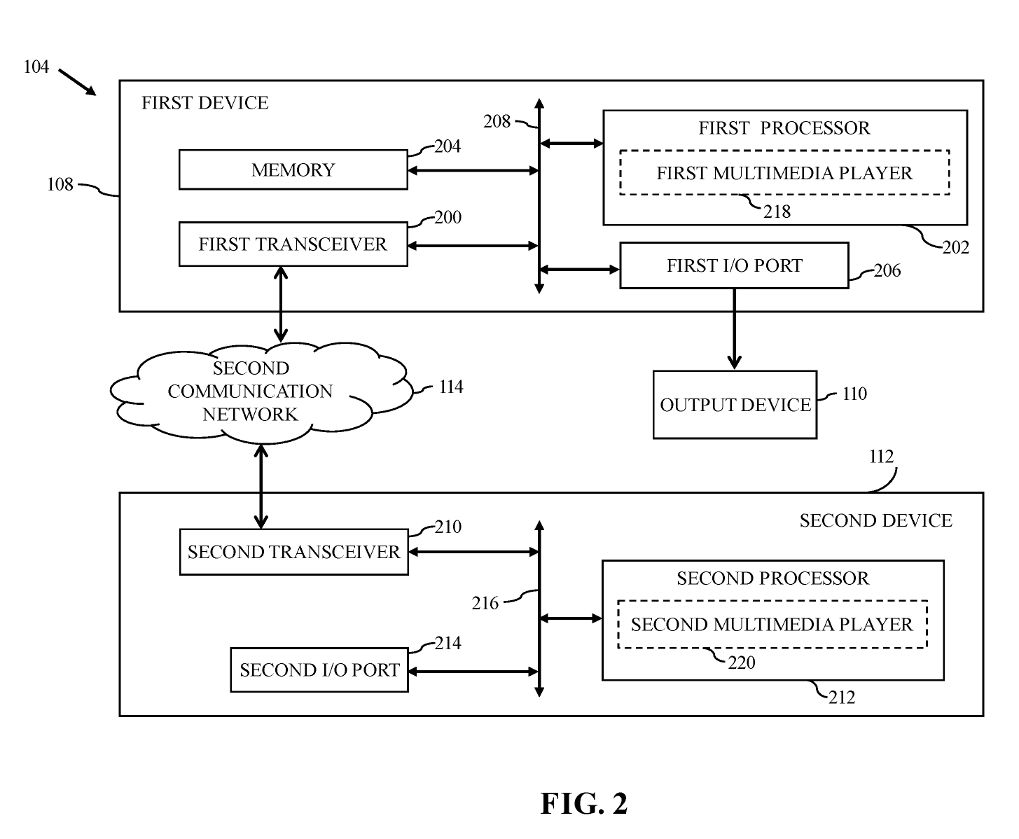

Referring now to FIG. 2, the first and second devices 108 and 112 of the system environment 100 in accordance with an embodiment of the present invention are shown. The first device 108 includes a first transceiver 200, a first processor 202, a memory 204, and a first input/output (I/O) port 206. The first transceiver 200, the first processor 202, the memory 204, and the first I/O port 206 communicate with each other by way of a first bus 208. The second device 112 includes a second transceiver 210, a second processor 212, and a second I/O port 214. The second transceiver 210, the second processor 212, and the second I/O port 214 communicate with each other by way of a second bus 216.

The first transceiver 200 includes suitable logic, circuitry, and/or interfaces to transmit or receive messages from various devices, such as the server 102 and the second transceiver 210. The first transceiver 200 communicates with the server 102 through the first communication network 106, and the second transceiver 210 through the second communication network 114. The first transceiver 200 receives the first multimedia file from the server 102. The first transceiver 200 transmits the first multimedia file to the second device 112. Examples of the first transceiver 200 include, but are not limited to, an antenna, a radio frequency transceiver, a wireless transceiver, a Bluetooth transceiver, and the like. The first transceiver 200 communicates with the server 102, the first processor 202, and the second transceiver 210 using various wired and wireless communication protocols, such as TCP/IP, UDP, 2^{nd} Generation (2G), 3¹⁴ Generation (3G), 4^{th} Generation (4G) communication protocols, or any combination thereof.

The first processor 202 includes suitable logic, circuitry, and/or interfaces to execute instructions stored in the memory 204. The first processor 202 receives and stores the first multimedia file in the memory 204. Further, the first processor 202 transmits the first multimedia file to the second transceiver 210 by way of the first transceiver 200. The first processor 202 further receives a control command from the second processor 212 for the playback of the first multimedia file. The first processor 202 further synchronizes the playback of the first audio component with the first video component based on the control command. In one example, the control command is one of a play command, a pause command, a resume command, a seek command, and a stop command. Examples of the first processor 202 include an application-specific integrated circuit (ASIC) processor, a reduced instruction set computing (RISC) processor, a complex instruction set computing (CISC) processor, a field-programmable gate array (FPGA), and the like. It will be apparent to a person skilled in the art that the first processor 202 is compatible with multiple operating systems. The first processor 202 plays the first audio component of the first multimedia file through the output device 110 by way of a first multimedia player 218. Examples of the first multimedia player 218 include Quicktime® player, Windows® Media Player, Video LAN client (VLC®) media player, RealPlayer®, iTunes®, and the like.

The memory 204 includes suitable logic, circuitry, and/or interfaces to store the first multimedia file. Examples of the memory 204 include, but are not limited to, a random access memory (RAM), a read-only memory (ROM), a programmable ROM (PROM), an erasable PROM (EPROM), and the like. The first I/O port 206 includes suitable logic, circuitry, and/or interfaces that connect the first device 108 to various input and output devices, such as the output device 110, of the vehicle 104. Examples of the first I/O port 206 include a universal serial bus (USB) port, an Ethernet port, and the like.

The second transceiver 210 includes suitable logic, circuitry, and/or interfaces to transmit or receive messages from various devices, such as the first transceiver 200. The second transceiver 210 communicates with the first transceiver 200 through the second communication network 114. The second transceiver 210 receives the first multimedia file from the first transceiver 200. Further, the second transceiver 210 transmits the control command to the first transceiver 200 for controlling the playback of the first multimedia file. Examples of the second transceiver 210 include, but are not limited to, an antenna, a radio frequency transceiver, a wireless transceiver, a Bluetooth transceiver, and the like. The second transceiver 210 communicates with the first transceiver 200 and the second processor 212 using various wired and wireless communication protocols, such as TCP/IP, UDP, 2G, 3G, 4G communication protocols, or any combination thereof.

The second processor 212 includes suitable logic, circuitry, and/or interfaces to provide a playback of the multimedia files requested by a passenger travelling in the vehicle 104. In an example, a passenger selects the first multimedia file. In one embodiment, the second processor 212 receives the first multimedia file and extracts the first video component. The second processor 212 further generates the control command based on an input provided by the passenger. Examples of the second processor 212 include an ASIC processor, a RISC processor, a CISC processor, an FPGA, and the like. It will be apparent to a person skilled in the art that the second processor 212 is compatible with multiple operating systems. The second processor 212 plays the first video component of the first multimedia file by way of a second multimedia player 220. Examples of the second multimedia player 220 include Quicktime® player, Windows® Media Player, Video LAN client (VLC®) media player, RealPlayer®, iTunes®, and the like.

The second I/O port 214 includes suitable logic, circuitry, and/or interfaces that provides an output to the passenger and further enables the passenger to provide an input for controlling a playback of various multimedia files. The second I/O port 214 may include output devices, such as a speaker, a Liquid crystal display (LCD) screen, a Light emitting diode (LED) screen, headphones, and the like. Further, the second I/O port 214 may include input devices, such as a touchscreen, a keyboard, a mouse, a joystick, a microphone, and the like.

In one embodiment, the first processor 202 in conjunction with the second processor 212 determines a lag time associated with the second communication network 114. For determining the lag time associated with the second communication network 114, the first processor 202 transmits a message to the second processor 212 through the second communication network 114. In one example, the message is a control command. The message is associated with a time stamp indicating a time instant at which the message is transmitted to the second processor 212. When the second processor 212 receives the message from the first processor 202, the second processor 212 transmits a response message to the first processor 202 through the second communication network 114. The first transceiver 200 receives the response message and communicates it to the first processor 202. Further, the first processor 202 determines a time instant at which the first transceiver 200 receives the response message. Thus, based on a difference between the time instant at which the first transceiver 200 receives the response message and the time stamp associated with the response message, the first processor 202 estimates a roundtrip time for communicating with the second processor 212 through the second communication network 114. Thus, based on the roundtrip time, the first processor 202 determines the lag time associated with the second communication network 114. It will be apparent to a person having skill in the relevant art that the first processor 202 determines the lag time based on the roundtrip time by using one or more known algorithms. The first processor 202 further communicates information pertaining to the lag time to the second processor 212 by way of the first transceiver 200.

In operation, the server 102 transmits the first multimedia file to the first device 108 through the first communication network 106. The first transceiver 200 receives the first multimedia file and stores the first multimedia file in the memory 204. The first processor 202 determines whether a ride has started. Alternatively stated, the first processor 202 determines whether a passenger has boarded the vehicle 104 for a ride. When the first processor 202 determines that the ride has started, the first transceiver 200 initiates a communication with the second transceiver 210 through the second communication network 114. Further, the first processor 202 transmits a set of identifiers associated with a corresponding set of multimedia files stored in the memory 204 to the second transceiver 210. In one example, the set of identifiers includes a first identifier associated with the first multimedia file. In one embodiment, the first identifier is a title of the first multimedia file.

The second transceiver 210 receives the set of identifiers. Further, the second processor 212 renders the set of identifiers through the second I/O port 214 for the passenger travelling in the vehicle 104. The passenger selects one identifier of the set of identifiers. In one example, the passenger selects a first identifier. In one embodiment, the passenger selects the first identifier by pressing a physical key on the second I/O port 214. In another embodiment, the passenger selects the first identifier by pressing a virtual key on the second I/O port 214. In yet another embodiment, the passenger selects the first identifier by directly clicking on the first identifier rendered through a Graphical User Interface (GUI). It will be apparent to a person skilled in the art that the passenger may use any other input providing mechanism known in the art for selecting the first identifier. The second transceiver 210 further transmits information pertaining to the selection of the first identifier to the first transceiver 200 through the second communication network 114.

The first transceiver 200 receives the information pertaining to the selection of the first identifier and communicates it to the first processor 202. The first processor 202 determines that the passenger wants to view the first multimedia file. Therefore, the first processor 202 transmits the first multimedia file to the second transceiver 210 by way of the first transceiver 200 through the second communication network 114. In one example, the first transceiver 200 streams the first video component to the second transceiver 210. The passenger provides an input from a set of inputs to control the playback of the first multimedia file. In one example, the passenger provides a first input to play the first multimedia file. In another example, the passenger provides a second input to pause the first multimedia file. In another example, the passenger provides a third input to resume the paused first multimedia file. In another example, the passenger provides a fourth input to seek, i.e., forward or rewind, the first multimedia file. In yet another example, the passenger provides a fifth input to stop the first multimedia file. The passenger provides the first through fifth inputs by pressing a physical key or virtual key on the second I/O port. It will be apparent to a person skilled in the art that the passenger may use any other input providing mechanism known in the art for providing the first through fifth inputs.

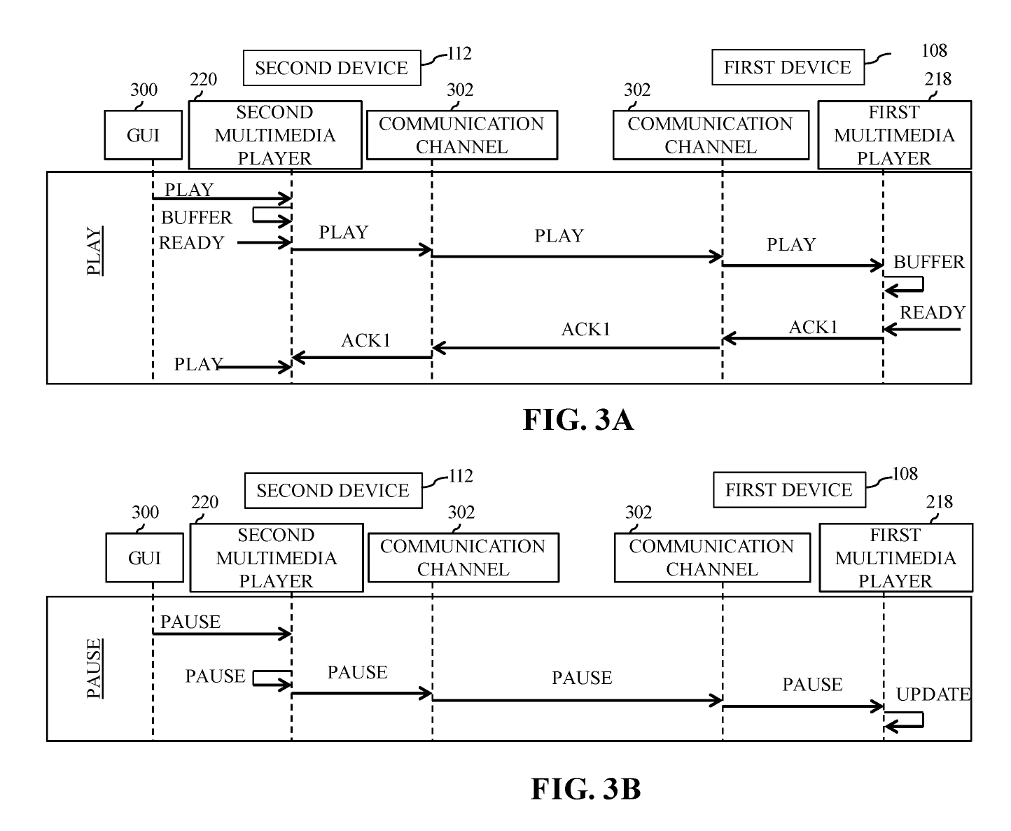

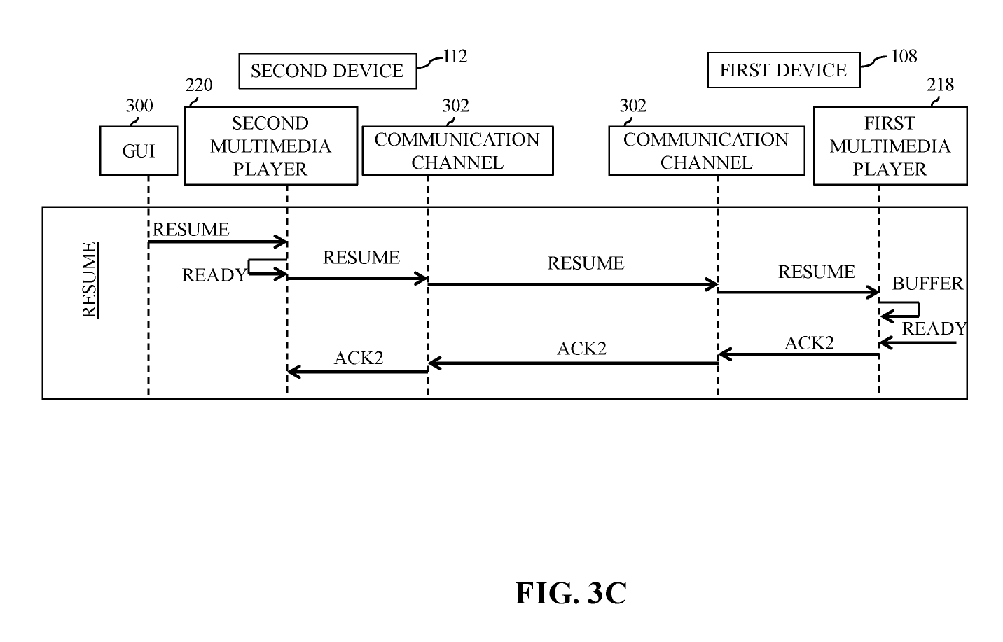

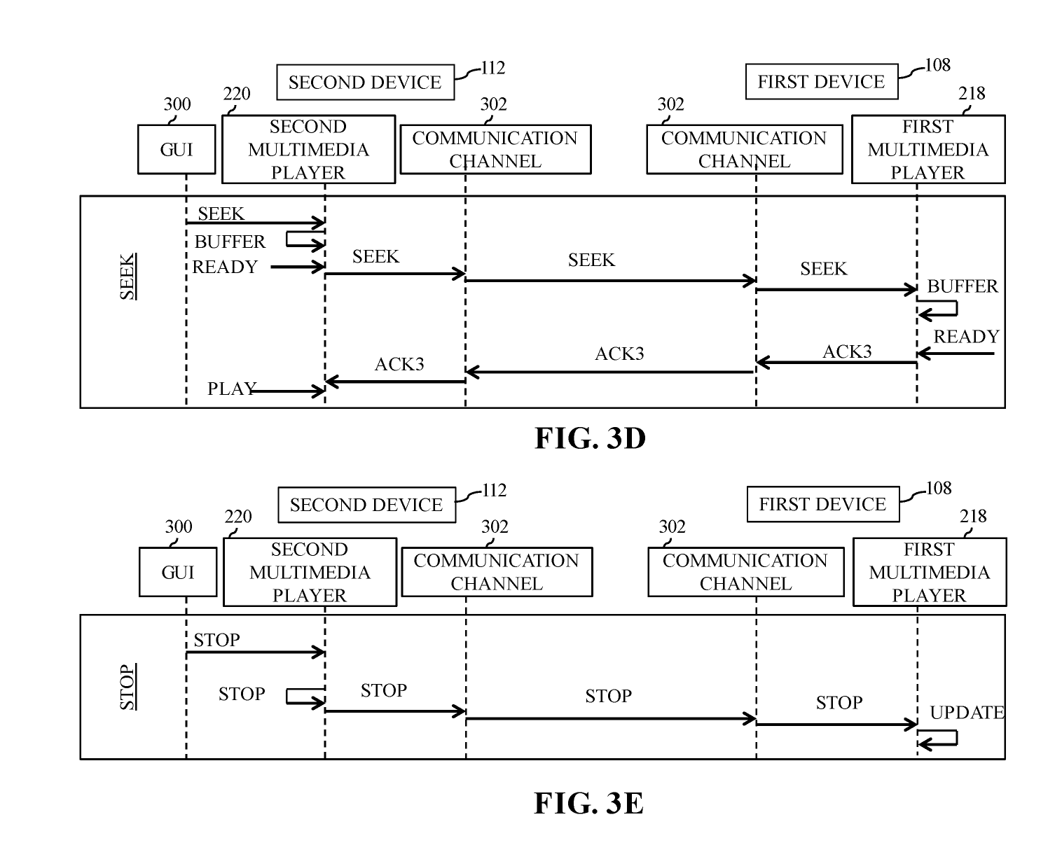

The second processor 212 generates a control command corresponding to the input provided by the passenger. In one example, the second processor 212 generates first through fifth control commands corresponding to the first through fifth inputs provided by the passenger, respectively. The second processor 212 transmits the control command to the first processor 202 by using the second transceiver 210 through the second communication network 114. Further, the first processor 202 receives the control command and synchronizes the playback of the first multimedia file based on the control command. The first processor 202 utilizes the control command and the lag time to ensure that a lip-sync error in the playback of the first audio and first video components through the first and second multimedia players 218 and 220, respectively, does not exceed a predetermined threshold. In one example, the predetermined threshold is 22 ms, which is not perceivable by a human eye. The functionality of the first and second processors 202 and 212 for synchronizing the playback of the first audio and first video components through the first and second multimedia players 218 and 220 is explained in FIGS. 3A-3E.

Thus, the system environment 100 provides a mechanism for synchronizing playback of multimedia files across multiple devices. The system environment 100 uses a set of control commands exchanged between the first device 108 and the second device 112 for synchronizing the playback of multimedia files. Therefore, the system environment 100 does not require additional hardware for synchronization. In addition, the system environment 100 provides a mechanism to synchronize audio and video components played on different multimedia players. Further, the system environment 100 offers another advantage that the passenger travelling in the vehicle 104 has total control over playback of the multimedia files. The first device 108 further has the capability to store the multimedia files in the memory 204. Hence, the passenger is not required to carry any additional hardware. In one embodiment, the first device 108 is capable of pairing with a passenger's personal device, thus a passenger can control the playback of the multimedia files by using his or her personal device.

Referring now to FIGS. 3A-3E, process flow diagrams for synchronizing the playback of multimedia files across the first and second devices 108 and 112 in accordance with an embodiment of the present invention are shown. FIG. 3A illustrates a process flow diagram for synchronizing the playback of the first multimedia file on the first and second devices 108 and 112 based on a “PLAY” command, i.e., when the passenger elects to play the first multimedia file by providing the first input through the second I/O port 214 of the second device 112, in accordance with an embodiment of the present invention.

The second processor 212 presents a GUI 300 to the passenger for providing the set of inputs to control the playback of the first multimedia file. The passenger provides the first input to play the first multimedia file through the GUI 300. The second multimedia player 220 receives the first input from the GUI 300. The second processor 212 receives the first input from the second multimedia player 220. Based on the first input, the second processor 212 initiates buffering of the first multimedia file. When the second processor 212 has buffered a predefined count of fragments of the first video component, the second processor 212 achieves a “READY” state and generates a play command “PLAY”. The second transceiver 210 transmits the play command “PLAY” to the first processor 202 by way of a communication channel 302 of the second communication network 114. When the first processor 202 receives the play command “PLAY”, it initiates buffering of the first audio component from the memory 204. When the first processor 202 has buffered the first audio component, the first processor 202 achieves a “READY” state and generates a first acknowledgement command “ACK1”. The first transceiver 200 transmits the first acknowledgement command “ACK1” to the second processor 212. The first and second processors 202 and 212 start playing the first audio and first video components, respectively, when the second processor 212 receives the first acknowledgement command“ACK1”, thereby synchronizing the playback of the first audio and first video components. The first processor 202 starts playing the first audio component when the lag time has elapsed as the second processor 212 receives the first acknowledgement command“ACK1” after the lag time. Hence, the playback of the first audio and first video components is synchronized. The second processor 212 renders the first video component by using the second multimedia player 220. The first processor 202 renders the first audio component by using the first multimedia player 218.

It will be apparent to a person having skill in the relevant art that the first processor 202 may not store the first multimedia file in the memory 204 and directly transmit to the second processor 212 without deviating from the scope of the invention.

FIG. 3B illustrates a process flow diagram for synchronizing the playback of the first multimedia file on the first and second devices 108 and 112 based on a “PAUSE” command, i.e., when the passenger elects to pause the first multimedia file by providing the second input through the second I/O port 214 of the second device 112 in accordance with an embodiment of the present invention.

The passenger provides the second input to pause the first multimedia file through the GUI 300. The second multimedia player 220 receives the second input from the GUI 300. The second processor 212 receives the second input from the second multimedia player 220. Based on the second input, the second processor 212 generates and transmits a pause command “PAUSE” to the first processor 202 by way of the communication channel 302 of the second communication network 114. When the first processor 202 receives the pause command “PAUSE”, the first and second processors 202 and 212 pause the first audio and first video components, respectively. The second device 112 pauses the first video component when the lag time has elapsed as the first processor 202 receives the pause command “PAUSE” after the lag time. Hence, the playback of the first audio and first video components is synchronized.

FIG. 3C illustrates a process flow diagram for synchronizing the playback of the first multimedia file on the first and second devices 108 and 112 based on a “RESUME” command, i.e., when the passenger elects to resume the first multimedia file by providing the third input through the second I/O port 214 of the second device 112 in accordance with an embodiment of the present invention.

The passenger provides the third input to resume the first multimedia file through the GUI 300. The second multimedia player 220 receives the third input from the GUI 300. The second processor 212 receives the third input from the second multimedia player 220. The second processor 212 is in the “READY” state and generates the resume command “RESUME”. The second transceiver 210 transmits the resume command “RESUME” to the first processor 202 through the communication channel 302 of the second communication network 114. When the first processor 202 receives the resume command “RESUME”, it initiates buffering of the first audio component from the memory 204. When the first processor 202 has buffered the first audio component, the first processor 202 achieves a “READY” state and generates a second acknowledgement command “ACK2”. The first transceiver 200 transmits the second acknowledgement command “ACK2” to the second processor 212. The first and second processors 202 and 212 resume playing the first audio and first video components, respectively, when the second processor 212 receives the second acknowledgement command “ACK2”, thereby synchronizing the playback of the first audio and first video components. Thus, the first processor 202 resumes playing the first audio component when the lag time has elapsed as the second processor 212 receives the second acknowledgement command “ACK2” after the lag time. Hence, the playback of the first audio and first video components is synchronized.

FIG. 3D illustrates a process flow diagram for synchronizing the playback of the first multimedia file on the first and second devices 108 and 112 based on a “SEEK” command, i.e., when the passenger elects to seek the first multimedia file by providing the fourth input through the second I/O port 214 of the second device 112 in accordance with an embodiment of the present invention.

The passenger provides the fourth input to seek the first multimedia file through the GUI 300. The second multimedia player 220 receives the fourth input from the GUI 300. The second processor 212 receives the fourth input from the second multimedia player 220. In one example, seeking the first multimedia file corresponds to forwarding the first multimedia file. In another example, seeking the first multimedia file corresponds to rewinding the first multimedia file. In one embodiment, the passenger forwards the playback of the first multimedia file to a first time stamp. Based on the fourth input, the second processor 212 initiates buffering of the first multimedia file up to the first time stamp to which the passenger has forwarded the playback of the first multimedia file. When the second processor 212 has buffered a predefined count of fragments of the first video component up to the first time stamp, the second processor 212 achieves a “READY” state and generates a seek command “SEEK”. The seek command “SEEK” includes information pertaining to the first time stamp. The second transceiver 210 transmits the seek command “SEEK” to the first processor 202 through the communication channel 302 of the second communication network 114. When the first processor 202 receives the seek command “SEEK”, it initiates buffering of the first audio component from the memory 204 up to the first time stamp. When the first processor 202 has buffered the first audio component, the first processor 202 achieves a “READY” state and generates a third acknowledgement command “ACK3”. The first transceiver 200 transmits the third acknowledgement command “ACK3” to the second processor 212. The first and second processors 202 and 212 start playing the first audio and first video components, respectively, from the first time stamp when the second processor 212 receives the third acknowledgement command “ACK3”, thereby synchronizing the playback of the first audio and first video components. Thus, the first processor 202 starts playing the first audio component from the first time stamp when the lag time has elapsed as the second processor 212 receives the third acknowledgement command “ACK3” after the lag time. Hence, the playback of the first audio and first video components is synchronized.

FIG. 3E illustrates a process flow diagram for synchronizing the playback of the first multimedia file on the first and second devices 108 and 112 based on a “STOP” command, i.e., when the passenger elects to stop the first multimedia file by providing the fifth input through the second I/O port 214 of the second device 112 in accordance with an embodiment of the present invention.

The passenger provides the fifth input to stop the first multimedia file through the GUI 300. The second multimedia player 220 receives the fifth input from the GUI 300. The second processor 212 receives the fifth input from the second multimedia player 220. Based on the fifth input, the second processor 212 transmits the stop command “STOP” to the first processor 202 through the communication channel 302 of the second communication network 114. When the first processor 202 receives the stop command “STOP”, the first and second processors 202 and 212 stop the first audio and first video components, respectively, thereby synchronizing the playback of the first audio and first video components. Thus, the second device 112 stops the first video component when the lag time has elapsed as the first processor 202 receives the stop command “STOP” after the lag time. Hence, the playback of the first audio and first video components is synchronized.

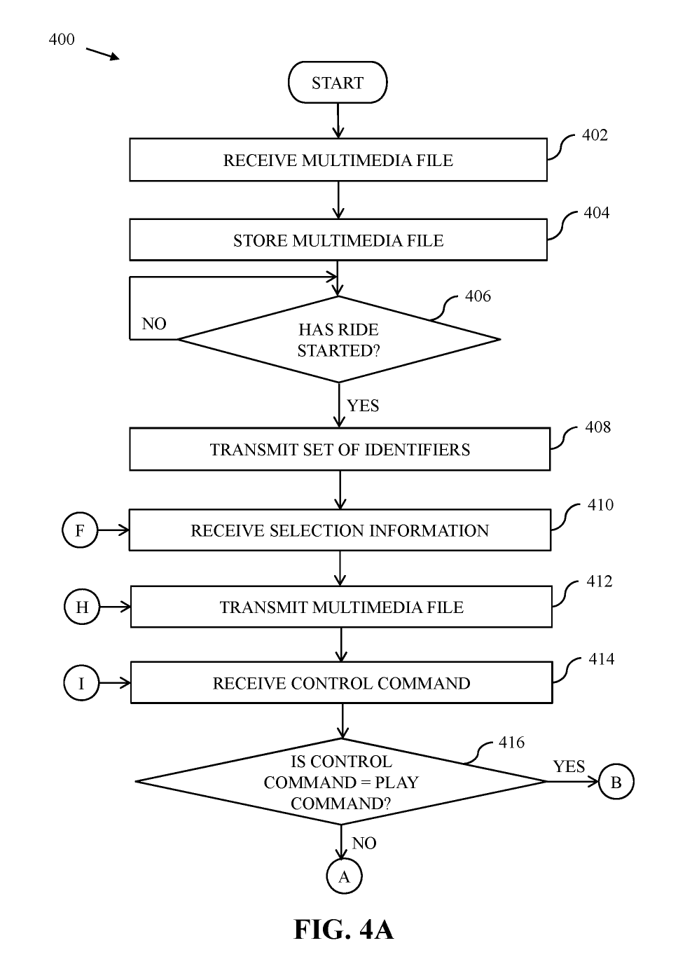

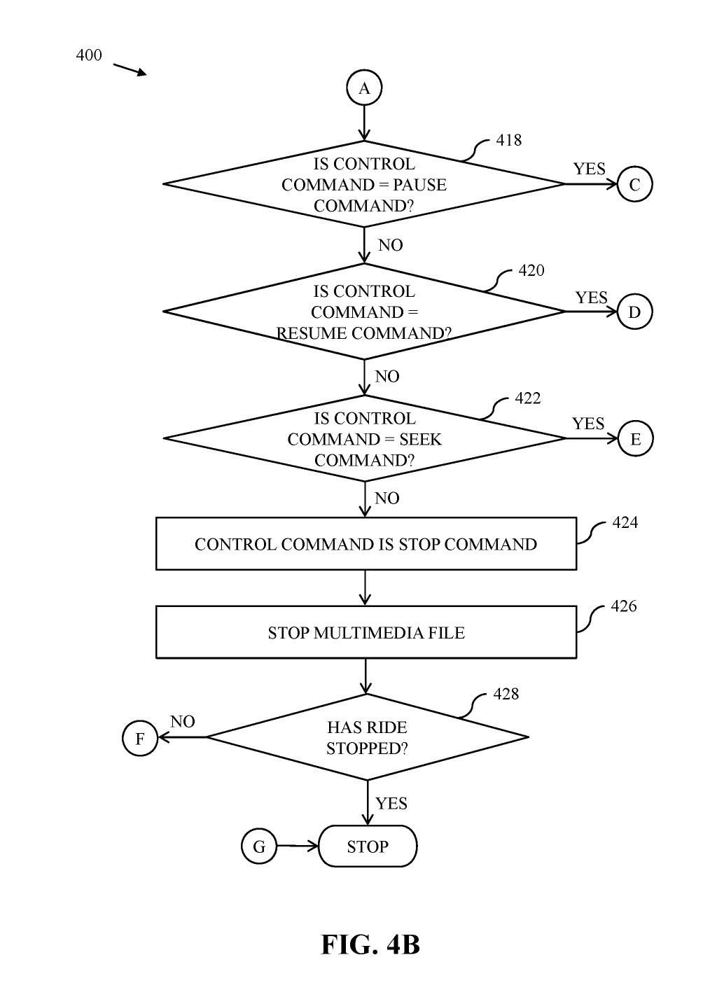

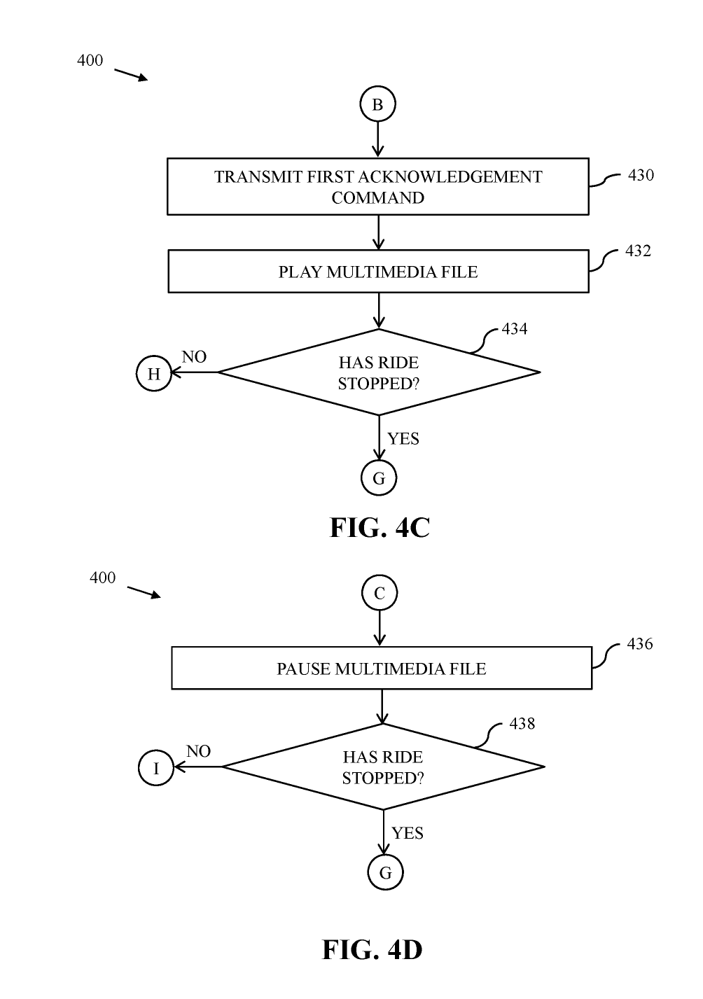

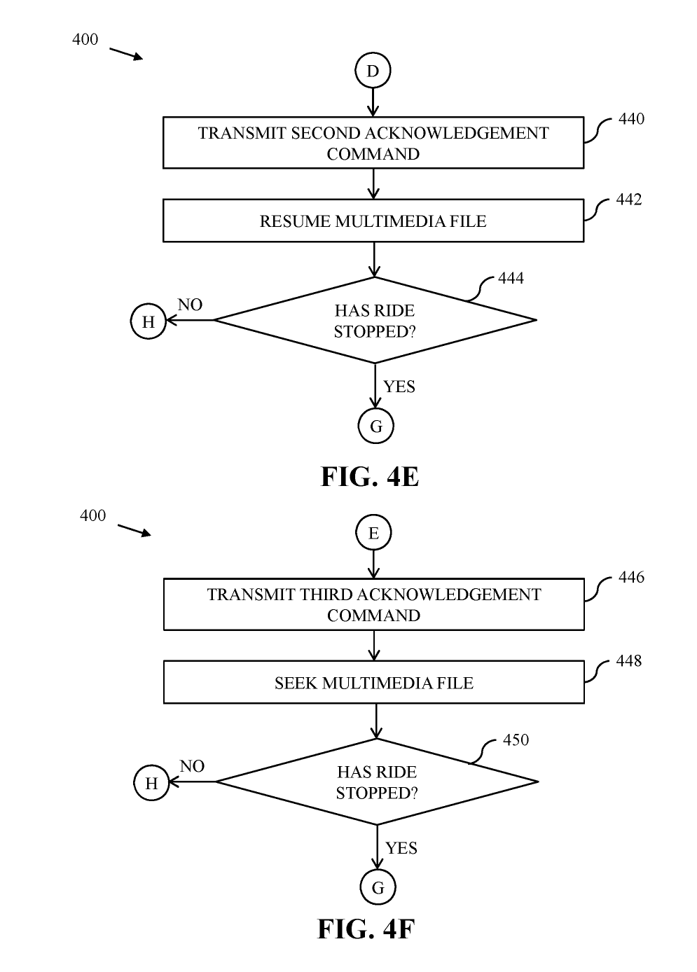

Referring now to FIGS. 4A-4F, a flowchart 400 that illustrates a method for synchronizing playback of the multimedia files across multiple devices of the system environment 100 in accordance with an embodiment of the present invention is shown.

Referring now to FIG. 4A, at step 402, the first processor 202 receives a multimedia file, i.e., the first multimedia file, from the server 102 by way of the first transceiver 200. The first multimedia file includes the first audio component and the first video component. At step 404, the first processor 202 stores the first multimedia file in the memory 204. It will be apparent to a person having ordinary skill in the relevant art that the first processor 202 may receive more than one multimedia files from the server 102.

At step 406, the first processor 202 determines whether the ride has started. Alternatively stated, the first processor 202 determines whether the passenger has boarded the vehicle 104 for the ride. If at step 406, it is determined that the ride has not started, the first processor 202 waits for the passenger to board the vehicle 104 and the ride to start. However, if at step 406 it is determined that the ride has started, step 408 is executed.

At step 408, the first processor 202 transmits a set of identifiers to the second processor 212 through the communication channel 302 of the second communication network 114. At step 410, the first processor 202 receives selection information, i.e., an input, pertaining to a first identifier selected by the passenger by way of the first transceiver 200. At step 412, the first processor 202 transmits the first multimedia file associated with the first identifier to the second processor 212 by way of the first transceiver 200.

At step 414, the first processor 202 receives a control command from the second processor 212. The second processor 212 generates and transmits the control command to the first processor 202 based on a first input provided by the passenger. At step 416, the first processor 202 determines whether the control command is the play command “PLAY”. If at step 416, it is determined that the control command is not the play command “PLAY”, step 418 is performed.

Referring now to FIG. 4B, at step 418, the first processor 202 determines whether the control command is the pause command “PAUSE”. If at step 418, it is determined that the control command is not the pause command “PAUSE”, step 420 is performed. At step 420, the first processor 202 determines whether the control command is the resume command “RESUME”. If at step 420, it is determined that the control command is not the resume command “RESUME”, step 422 is performed. At step 422, the first processor 202 determines whether the control command is the seek command “SEEK”. If at step 422, it is determined that the control command is not the seek command “SEEK”, step 424 is performed.

At step 424, the first processor 202 determines that the control command is the stop command “STOP”. At step 426, the first processor 202 in conjunction with the second processor 212 stops the first multimedia file on the first and second multimedia players 218 and 220, respectively. The first processor 202 stops the first audio component and the second processor 212 stops the first video component, when the first processor 202 receives the stop command “STOP”. Thus, the second processor 212 stops the first video component when the lag time of the second communication network 114 has elapsed. Hence, the playback of the first audio and first video components is synchronized.

At step 428, the first processor 202 determines whether the ride has stopped. If at step 428, it is determined that the ride has not stopped step 410 is performed. However, if at step 428, it is determined that the ride has stopped, the first processor 202 ends the communication with the second device 112.

If at step 416, it is determined that the control command is the play command “PLAY” step 430 is performed. Referring now to FIG. 4C, at step 430, the first processor 202 transmits the first acknowledgement command “ACK1” to the second processor 212 by way of the first transceiver 200. At step 432, the first processor 202 in conjunction with the second processor 212 plays the first multimedia file. The first processor 202 plays the first audio component and the second processor 212 plays the first video component, when the second processor 212 receives the first acknowledgement command “ACK1”. Thus, the second processor 212 plays the first video component when the lag time of the second communication network 114 has elapsed. Hence, the playback of the first audio and first video components is synchronized.

At step 434, the first processor 202 determines whether the ride has stopped. If at step 434, it is determined that the ride has not stopped step 412 is performed. However, if at step 434, it is determined that the ride has stopped, the first processor 202 ends the communication with the second device 112.

If at step 418, it is determined that the control command is the pause command “PAUSE” step 436 is performed. Referring now to FIG. 4D, at step 436, the first processor 202 in conjunction with the second processor 212 pauses the first multimedia file. The first processor 202 pauses the first audio component and the second processor 212 pauses the first video component, when the first processor 202 receives the pause command “PAUSE”. Thus, the second processor 212 pauses the first video component when the lag time of the second communication network 114 has elapsed. Hence, the playback of the first audio and first video components is synchronized.

At step 438, the first processor 202 determines whether the ride has stopped. If at step 438, it is determined that the ride has not stopped step 414 is performed. However, if at step 438, it is determined that the ride has stopped, the first processor 202 ends the communication with the second device 112.

If at step 420, it is determined that the control command is the resume command “RESUME” step 440 is performed. Referring now to FIG. 4E, at step 440, the first processor 202 transmits the second acknowledgement command “ACK2” to the second processor 212 by way of the first transceiver 200. At step 442, the first processor 202 in conjunction with the second processor 212 resumes the first multimedia file. The first processor 202 resumes the first audio component and the second processor 212 resumes the first video component, when the second processor 212 receives the second acknowledgement command “ACK2”. Thus, the second processor 212 resumes the first video component when the lag time of the second communication network 114 has elapsed. Hence, the playback of the first audio and first video components is synchronized.

At step 444, the first processor 202 determines whether the ride has stopped. If at step 444, it is determined that the ride has not stopped step 412 is performed. However, if at step 444, it is determined that the ride has stopped, the first processor 202 ends the communication with the second device 112.

If at step 422, it is determined that the control command is the seek command “SEEK” step 446 is performed. Referring now to FIG. 4F, at step 446, the first processor 202 transmits the third acknowledgement command “ACK3” to the second processor 212 by way of the first transceiver 200. At step 448, the first processor 202 in conjunction with the second processor 212 seeks the first multimedia file to a time instant inputted by the passenger. The first processor 202 seeks the first audio component and the second processor 212 seeks the first video component, when the second processor 212 receives the third acknowledgement command “ACK3”. Thus, the second processor 212 seeks the first video component when the lag time of the second communication network 114 has elapsed. Hence, the playback of the first audio and first video components is synchronized.

At step 450, the first processor 202 determines whether the ride has stopped. If at step 450, it is determined that the ride has not stopped step 412 is performed. However, if at step 450, it is determined that the ride has stopped, the first processor 202 ends the communication with the second device 112.

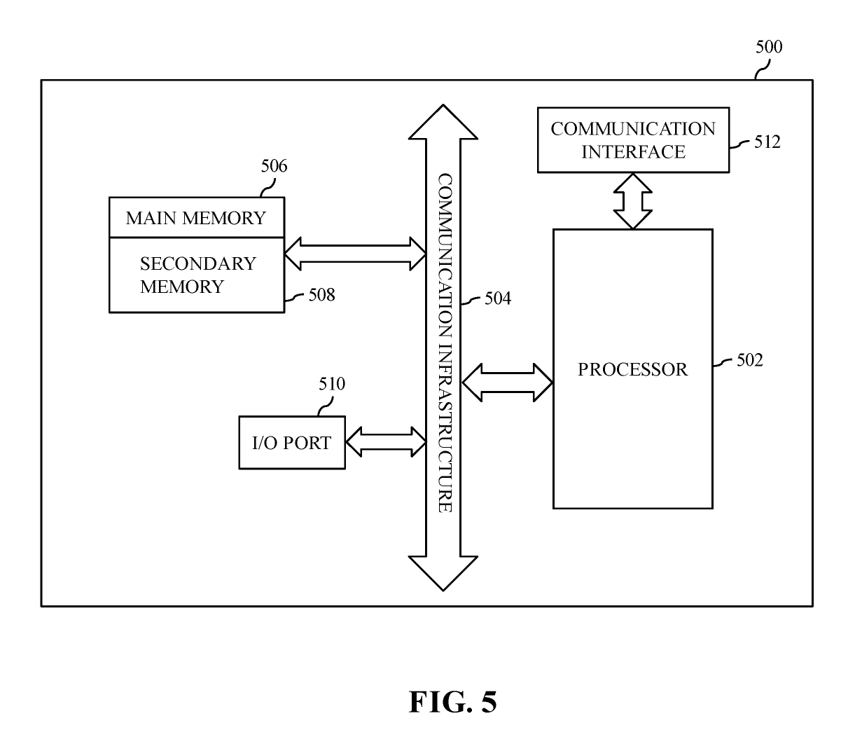

Referring now to FIG. 5, a block diagram of a computer system 500 for synchronizing the playback of multimedia files across multiple devices in the system environment 100 according to an embodiment of the present invention is shown. An embodiment of present invention, or portions thereof, may be implemented as computer readable code on the computer system 500. In one example, the server 102, the first device 108, and the second device 112 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIGS. 4A-4F.

The computer system 500 includes a processor 502 that may be a special purpose or a general purpose processing device. The processor 502 may be a single processor, multiple processors, or combinations thereof. The processor 502 may have one or more processor “cores.” Further, the processor 502 may be connected to a communication infrastructure 504, such as a bus, a bridge, a message queue, the second communication network 114, multi-core message-passing scheme, and the like. The computer system 500 further includes a main memory 506 and a secondary memory 508. Examples of the main memory 506 may include random access memory (RAM), read-only memory (ROM), and the like. The secondary memory 508 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The computer system 500 further includes an input/output (I/O) port 510 and a communication interface 512. The I/O port 510 includes various input and output devices that are configured to communicate with the processor 502. Examples of the input devices may include a keyboard, a mouse, a joystick, a touchscreen, a microphone, and the like. Examples of the output devices may include a display screen, a speaker, headphones, and the like. The communication interface 512 may be configured to allow data to be transferred between the computer system 500 and various devices that are communicatively coupled to the computer system 500. Examples of the communication interface 512 may include a modem, a network interface, i.e., an Ethernet card, a communications port, and the like. Data transferred via the communication interface 512 may correspond to signals, such as electronic, electromagnetic, optical, or other signals as will be apparent to a person skilled in the art. The signals may travel via a communications channel, such as the communication channel 302, which may be configured to transmit the signals to devices that are communicatively coupled to the computer system 500. Examples of the communication channel may include, but are not limited to, cable, fiber optics, a phone line, a cellular phone link, a radio frequency link, a wireless link, and the like.

Computer program medium and computer usable medium may refer to memories, such as the main memory 506 and the secondary memory 508, which may be a semiconductor memory such as dynamic RAMs. These computer program mediums may provide data that enables the computer system 500 to implement the method illustrated in FIGS. 4A-4F. In an embodiment, the present invention is implemented using a computer implemented application, such as the first and second multimedia players 218 and 220. The computer implemented application may be stored in a computer program product and loaded into the computer system 500 using the removable storage drive or the hard disc drive in the secondary memory 508, the I/O port 510, or the communication interface 512.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 502 and a memory such as the main memory 506 and the secondary memory 508 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present invention provide, among other features, systems and methods for offline playback of multimedia files. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

1. A system for synchronizing a multimedia file shared between two or more devices, the system comprising:
a first device comprising:
a memory configured to store the multimedia file, wherein the multimedia file includes at least an audio component and a video component; and
a processor that communicates with the memory, wherein the processor is configured to:
transmit the multimedia file to a second device by way of a first communication network;
receive a plurality of control commands from the second device; and
synchronize a playback of the audio component with the video component based on the plurality of control commands, wherein the first device renders the audio component by way of a first multimedia player, and the second device renders the video component by way of a second multimedia player.

2. The system of claim 1, wherein the processor is further configured to receive the multimedia file from a server by way of a second communication network.

3. The system of claim 1, wherein the second device receives first through fifth inputs and generates first through fifth control commands of the plurality of control commands based on the first through fifth inputs, respectively, and wherein the first control command is a play command, the second control command is a pause command, the third control command is a resume command, the fourth control command is a seek command, and the fifth control command is a stop command.

4. The system of claim 1, wherein the processor is further configured to:
receive a play command of the plurality of control commands;
generate an acknowledgement command; and
transmit the acknowledgement command to the second device, wherein the first and second devices play the audio and video components, respectively, when the second device receives the acknowledgement command, thereby synchronizing the playback of the audio component with the video component.

5. The system of claim 1, wherein the first device is further configured to:
receive a seek command of the plurality of control commands;
generate an acknowledgement command; and
transmit the acknowledgement command to the second device, wherein the first and second devices render the audio and video components, respectively, when the second device receives the acknowledgement command, thereby synchronizing the playback of the audio component with the video component.

6. The system of claim 1, wherein the first device is further configured to:
receive a stop command of the plurality of control commands, wherein the first and second devices stop the audio and video components, respectively, when the first device receives the stop command, thereby synchronizing the playback of the audio component with the video component.

7. The system of claim 1, wherein the first device is further configured to:
receive a pause command of the plurality of control commands; and
pause the audio component, wherein the first and second devices pause the audio and video components, respectively, when the first device receives the pause command, thereby synchronizing the playback of the audio component with the video component.

8. The system of claim 1, wherein the first device is further configured to:
receive a resume command of the plurality of control commands;
generate an acknowledgement command; and
transmit the acknowledgement command to the second device, wherein the first and second devices resume the audio and video components, respectively, when the second device receives the acknowledgement command, thereby synchronizing the playback of the audio component with the video component.

9. The system of claim 1, wherein the processor is further configured to determine a lag time based on the plurality of control commands for synchronizing the playback of the audio component with the video component.

10. A method for synchronizing a multimedia file shared between two or more devices, the method comprising:
receiving, by a first device, the multimedia file, wherein the multimedia file includes at least an audio component and a video component;
transmitting, by the first device, the multimedia file to a second device by way of a first communication network;
receiving, by the first device, a plurality of control commands from the second device; and
synchronizing, by the first device, a playback of the audio component with the video component based on the plurality of control commands, wherein the first device renders the audio component by way of a first multimedia player, and wherein the second device renders the video component by way of a second multimedia player.

11. The method of claim 10, further comprising:
receiving, by the first device, the multimedia file from a server by way of a second communication network.

12. The method of claim 10, wherein the second device receives first through fifth inputs and generates first through fifth control commands of the plurality of control commands based on the first through fifth inputs, respectively, and wherein the first control command is a play command, the second control command is a pause command, the third control command is a resume command, the fourth control command is a seek command, and the fifth control command is a stop command.

13. The method of claim 10, further comprising:
receiving, by the first device, a play command of the plurality of control commands;
generating, by the first device, an acknowledgement command; and
transmitting, by the first device, the acknowledgement command to the second device, wherein the first and second devices play the audio and video components, respectively, when the second device receives the acknowledgement command, thereby synchronizing the playback of the audio component with the video component.

14. The method of claim 10, further comprising:
receiving, by the first device, a seek command of the plurality of control commands;
generating, by the first device, an acknowledgement command; and
transmitting, by the first device, the acknowledgement command to the second device, wherein the first and second devices render the audio and video components, respectively, when the second device receives the acknowledgement command, thereby synchronizing the playback of the audio component with the video component.

15. The method of claim 10, further comprising:
receiving, by the first device, a stop command of the plurality of control commands, wherein the first and second devices stop the audio and video components, respectively, when the first device receives the stop command, thereby synchronizing the playback of the audio component with the video component.

16. The method of claim 10, further comprising:
receiving, by the first device, a pause command of the plurality of control commands, wherein the first and second devices pause the audio and video components, respectively, when the first device receives the pause command, thereby synchronizing the playback of the audio component with the video component.

17. The method of claim 10, further comprising:
receiving, by the first device, a resume command of the plurality of control commands;
generating, by the first device, an acknowledgement command; and
transmitting, by the first device, the acknowledgement command to the second device, wherein the first and second devices resume the audio and video components, respectively, when the first device receives the acknowledgement command, thereby synchronizing the playback of the audio component with the video component.

18. The method of claim 10, further comprising:
determining, by the first device, a lag time based on the plurality of control commands for synchronizing the playback of the audio component with the video component.
